(19) United States
(12) Patent Application Publication
(10) Pub. No.: US 2011/0153458 A1
(43) Pub. Date: Jun. 23, 2011

(54) APPROVAL WORKFLOW ENGINE AND APPROVAL FRAMEWORK FOR PURCHASE ORDERS

(75) Inventors: Elaine Wong, San Ramon, CA (US); Earnest Ivie, Keller, TX (US); Julie LeBlanc, Pleasanton, CA (US); Shawn Abernathy, Boulder Creek, CA (US); Saritha Surapaneni, Dublin, CA (US)

(73) Assignee: Oracle International Corporation, Redwood Shores, CA (US)

(21) Appl. No.: 12/641,069

(22) Filed: Dec. 17, 2009

(51) Int. Cl. G06Q 10/00; G06Q 30/00; G06F 3/01

(52) U.S. Cl. 705/26.82; 705/301; 715/751

(57) ABSTRACT

This disclosure describes, generally, methods and systems for implementing a purchase order approval workflow engine and approval framework. The method includes receiving, at an approval engine of an application server from a purchaser, a purchase order, wherein the purchase order includes a plurality of line items, applying, by the approval engine, one or more rules associated with the purchase order, and transmitting the purchase order to one or more approvers. The method further includes receiving, from the one or more approvers, approval for each of the plurality of line items. The approval of each line item is completed independent from any other line item. Further, the method includes receiving, at the approval engine, an indication that each of the plurality of line items are approved, and transmitting, to a supplier, the purchase order.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to purchase order approval and, more particularly, to approval workflow and frameworks for purchase order approval.

### BACKGROUND

Presently, purchase orders are submitted by buyers to procure goods and services from a supplier. Purchase orders must be routed to certain individuals in, for example, the management chain to obtain fiscal amount or chartfield approvals before the purchase order can be dispatched to, for example, a vendor. Thus, purchasing implementations only offer two limited ways to handle purchase order approvals: 1) approvals using a virtual approver which is role-based and is workflow-enabled, or 2) single level approval with security defined at the applications' user preferences and does not have any workflow.

Unfortunately, both of these solutions are based at the document level (or header level), and both only allow online approval actions for a single purchase order. Solution 2) is a very simple one-step approval and does not have any associated workflow, while solution 1) uses a virtual approver and supports role-based, multi-step approval routings. Solution 1 nonetheless, requires technical knowledge and access to an application designer in order to complete the required setup, and offers only the option to approve or deny and is restrictive to only two kinds of approvals namely: purchase order amount approval and purchase order chartfield approval. Hence, improvements in the art are needed.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized schematic diagram illustrating a computer system, in accordance with various embodiments of the present invention.

FIG. 2 is a block diagram illustrating a networked system of computers, which can be used in accordance with various embodiments of the present invention.

FIG. 3 is a flow diagram illustrating a method of implementing a purchase order approval workflow engine and approval framework, in accordance with one embodiment of the present invention.

FIG. 4 is a flow diagram illustrating a method of implementing a purchase order approval workflow engine and approval framework, in accordance with another embodiment of the present invention.

FIG. 5 is a flow diagram illustrating a method of setting business unit options for an approval framework workflow, in accordance with another embodiment of the present invention.

FIG. 6 is a block diagram illustrating a system for implementing a purchase order approval workflow engine and approval framework, in accordance with another embodiment of the present invention.

FIG. 7 is a user interface which provides for setting business unit options for an approval framework workflow, in accordance with another embodiment of the present invention.

FIGS. 8A and 8B are user interfaces which provide for an approval framework workflow purchase order view, in accordance with another embodiment of the present invention.

FIG. 9 is a user interface which provides for an approval framework workflow line level purchase order approval view, in accordance with another embodiment of the present invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the present invention provide for an easily configured approval and routing rules using a flexible, extensible, and comprehensive approval management tool. Further the present invention provides for the ability to follow status of the approval process in a graphical view. Furthermore, the present invention provides the ability to: approve an entire transaction or a line, deny an entire transaction, resubmit the entire transaction or line for re-approval after a change has been made, push back the transaction or line to the prior approver, hold the entire transaction or a line while obtaining more information, add or remove ad-hoc approvers or reviewers, notify approver via work list or email, generate in-line email approval, approve or deny a transaction using email, manage multiple approvals at the same time, etc.

Additionally, aspects of the present invention provide for a business unit option to enable an approval framework workflow. For example, the ability to change a template (e.g., identify fields that, when changed, will reinitiate the approval process resulting in re-evaluating the re-approval of a line and/or header) is provided (e.g., a change to the template may not result in another approval). Further, aspects of the present invention provide for configuration approval framework workflow, which provides the ability to define user profiles and roles, define user lists, review the approval transaction registry, configure the approval transaction, set up process definitions, authorize approvers and roles for dynamic approval, set up approval user monitors, define ad hoc notification templates, set up email approvals, etc.

Further aspects of the present invention relate to an enterprise components approval workflow engine/approval framework which may be implemented within an enterprise purchasing for use with purchase orders. In one embodiment, customers will be able to define rules for automatic assignment of multi-level approvers, based on any the attributes of a specific purchase order, not just amount and chartfield. Customers may further be able to provide the approvers with the option to approve, deny, or push back a purchase order, as well as provide approvers and submitters with visibility of a full approval path and current approval status throughout the approval process. In addition, post approval adjustments can be routed for approval based on adjustment approval rules defined, and multiple purchase orders can be approved or denied online in a consolidated view.

Furthermore, with the introduction of the approval workflow engine/approval framework for enterprise purchasing, the individual lines of the purchase order or entire purchase order can be routed through different approval routings as well as multiple levels of approval. The appropriate approvers may be selected automatically by the system based on the predefined rules for specific attributes of the current transaction.

Some benefits of the present invention include: extensible architecture with multiple stages, paths and steps for approval transactions, the ability to have multiple approvers and/or reviewers tied to lowest level, the ability to dynamically add approvers to the approval process, the ability to define rule context like header level, line level, etc., the ability to submit a line for post approval adjustments if changed without re-submitting the entire transaction, and the ability to trigger approvals based on business rules embedded in the approval process definition (e.g., VP level approval required if cost >$10,000).

Use of the present invention provides more flexibility and an automated mechanism for the assignment of purchase order approvers, while ensuring consistency and compliance to the customer's approval guidelines. The present invention also provides full visibility of approval history for a purchase order transaction.

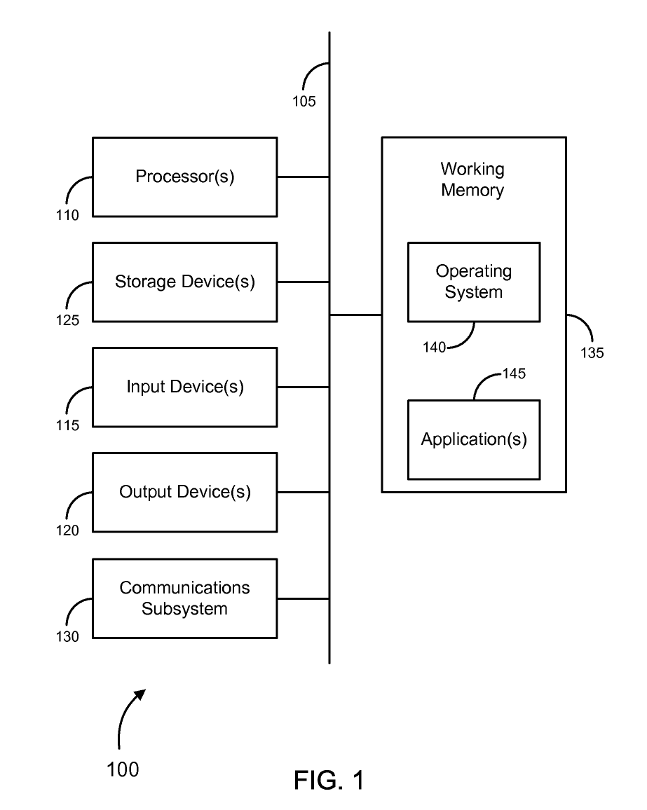

FIG. 1 provides a schematic illustration of one embodiment of a computer system 100 that can perform the methods of the invention, as described herein. It should be noted that FIG. 1 is meant only to provide a generalized illustration of various components, any or all of which may be utilized as appropriate. FIG. 1, therefore, broadly illustrates how individual system elements may be implemented in a relatively separated or relatively more integrated manner.

The computer system 100 is shown comprising hardware elements that can be electrically coupled via a bus 105 (or may otherwise be in communication, as appropriate). The hardware elements can include one or more processors 110, including without limitation, one or more general purpose processors and/or one or more special purpose processors (such as digital signal processing chips, graphics acceleration chips, and/or the like); one or more input devices 115, which can include without limitation a mouse, a keyboard and/or the like; and one or more output devices 120, which can include without limitation a display device, a printer and/or the like.

The computer system 100 may further include (and/or be in communication with) one or more storage devices 125, which can comprise, without limitation, local and/or network-accessible storage and/or can include, without limitation, a disk drive, a drive array, an optical storage device, a solid state storage device such as a random access memory (“RAM”) and/or a read-only memory (“ROM”), which can be programmable, flash updateable and/or the like. The computer system 100 might also include a communications subsystem 130, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 130 may permit data to be exchanged with a network (such as the network described below, to name one example), and/or any other devices described herein. In many embodiments, the computer system 100 will further comprise a working memory 135, which can include a RAM or ROM device, as described above.

The computer system 100 also can comprise software elements, shown as being currently located within the working memory 135, including an operating system 140 and/or other code, such as one or more application programs 145, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 125 described above. In some cases, the storage medium might be incorporated within a computer system, such as the system 100. In other embodiments, the storage medium might be separate from a computer system (i.e., a removable medium, such as a compact disc, etc.), and is provided in an installation package, such that the storage medium can be used to program a general purpose computer with the instructions/code stored thereon. These instructions might take the form of executable code, which is executable by the computer system 100 and/or might take the form of source and/or installable code, which, upon compilation and/or installation on the computer system 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 100) to perform methods of the invention. According to a set of embodiments, some or all of the procedures of such methods are performed by the computer system 100 in response to processor 110 executing one or more sequences of one or more instructions (which might be incorporated into the operating system 140 and/or other code, such as an application program 145) contained in the working memory 135. Such instructions may be read into the working memory 135 from another machine-readable medium, such as one or more of the storage device(s) 125. Merely by way of example, execution of the sequences of instructions contained in the working memory 135 might cause the processor(s) 110 to perform one or more procedures of the methods described herein.

The terms “machine-readable medium” and “computer readable medium,” as used herein, refer to any medium that participates in providing data that causes a machine to operate in a specific fashion. In an embodiment implemented using the computer system 100, various machine-readable media might be involved in providing instructions/code to processor(s) 110 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 125. Volatile media includes, without limitation, dynamic memory, such as the working memory 135. Transmission media includes coaxial cables, copper wire and fiber optics, including the wires that comprise the bus 105, as well as the various components of the communications subsystem 130 (and/or the media by which the communications subsystem 130 provides communication with other devices). Hence, transmission media can also take the form of waves (including without limitation radio, acoustic and/or light waves, such as those generated during radio wave and infrared data communications).

Common forms of physical and/or tangible computer-readable media include, for example, a floppy disk, a flexible disk, a hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals and/or the like, are all examples of carrier waves on which instructions can be encoded, in accordance with various embodiments of the invention.

The communications subsystem 130 (and/or components thereof) generally will receive the signals, and the bus 105 then might carry the signals (and/or the data, instructions, etc., carried by the signals) to the working memory 135, from which the processor(s) 110 retrieves and executes the instructions. The instructions received by the working memory 135 may optionally be stored on a storage device 125 either before or after execution by the processor(s) 110.

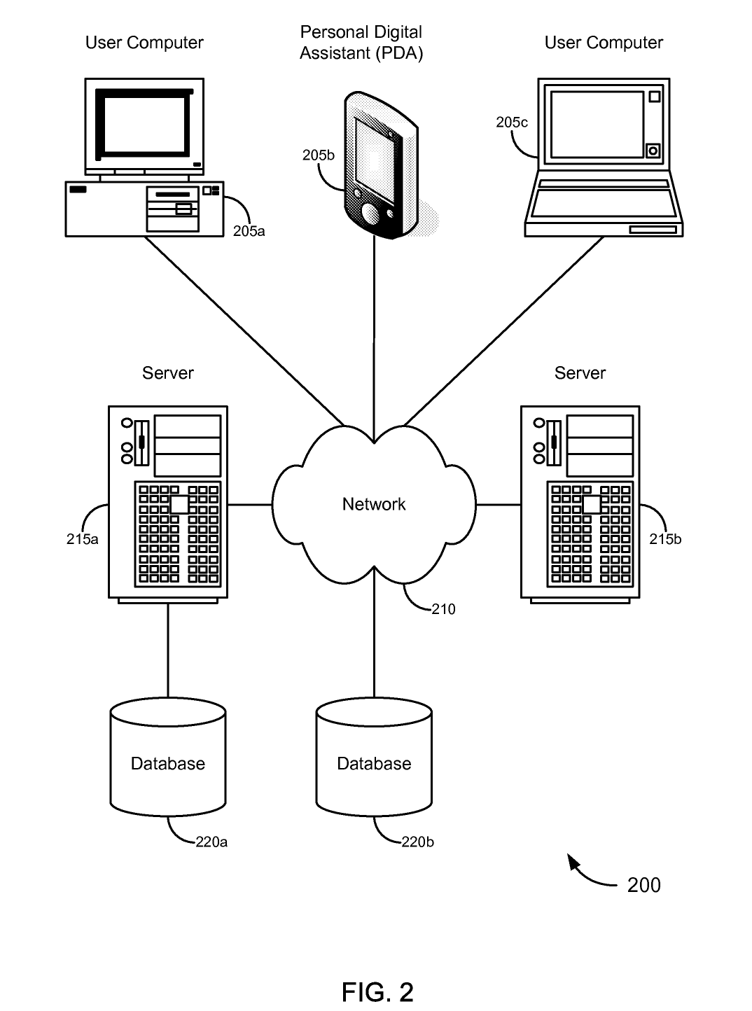

Merely by way of example, FIG. 2 illustrates a schematic diagram of a system 200 that can be used in accordance with one set of embodiments. The system 200 can include one or more user computers 205. The user computers 205 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, Internet-enabled mobile telephone, and/or personal digital assistant (PDA), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more clients 205 and/or other servers 215.

Merely by way of example, one of the servers 215 may be a web server, which can be used, merely by way of example, to process requests for web pages or other electronic documents from user computers 205. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 205 to perform methods of the invention.

The server computers 215, in some embodiments, might include one or more application servers, which can include one or more applications accessible by a client running on one or more of the client computers 205 and/or other servers 215. Merely by way of example, the server(s) 215 can be one or more general purpose computers capable of executing programs or scripts in response to the user computers 205 and/or other servers 215, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 205 and/or another server 215. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 205 via a web server (as described above, for example). Similarly, a web server might receive web page requests and/or input data from a user computer 205 and/or forward the web page requests and/or input data to an application server. In some cases a web server may be integrated with an application server.

In accordance with further embodiments, one or more servers 215 can function as a file server and/or can include one or more of the files (e.g., application code, data files, etc.) necessary to implement methods of the invention incorporated by an application running on a user computer 205 and/or another server 215. Alternatively, as those skilled in the art will appreciate, a file server can include all necessary files, allowing such an application to be invoked remotely by a user computer 205 and/or server 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 220. The location of the database(s) 220 is discretionary. Merely by way of example, a database 220a might reside on a storage medium local to (and/or resident in) a server 215a (and/or a user computer 205). Alternatively, a database 220b can be remote from any or all of the computers 205, 215, so long as the database can be in communication (e.g., via the network 210) with one or more of these. In a particular set of embodiments, a database 220 can reside in a storage-area network (“SAN”) familiar to those skilled in the art. (Likewise, any necessary files for performing the functions attributed to the computers 205, 215 can be stored locally on the respective computer and/or remotely, as appropriate.) In one set of embodiments, the database 220 can be a relational database, such as an Oracle™ database, that is adapted to store, update, and retrieve data in response to SQL-formatted commands. The database might be controlled and/or maintained by a database server, as described above, for example.

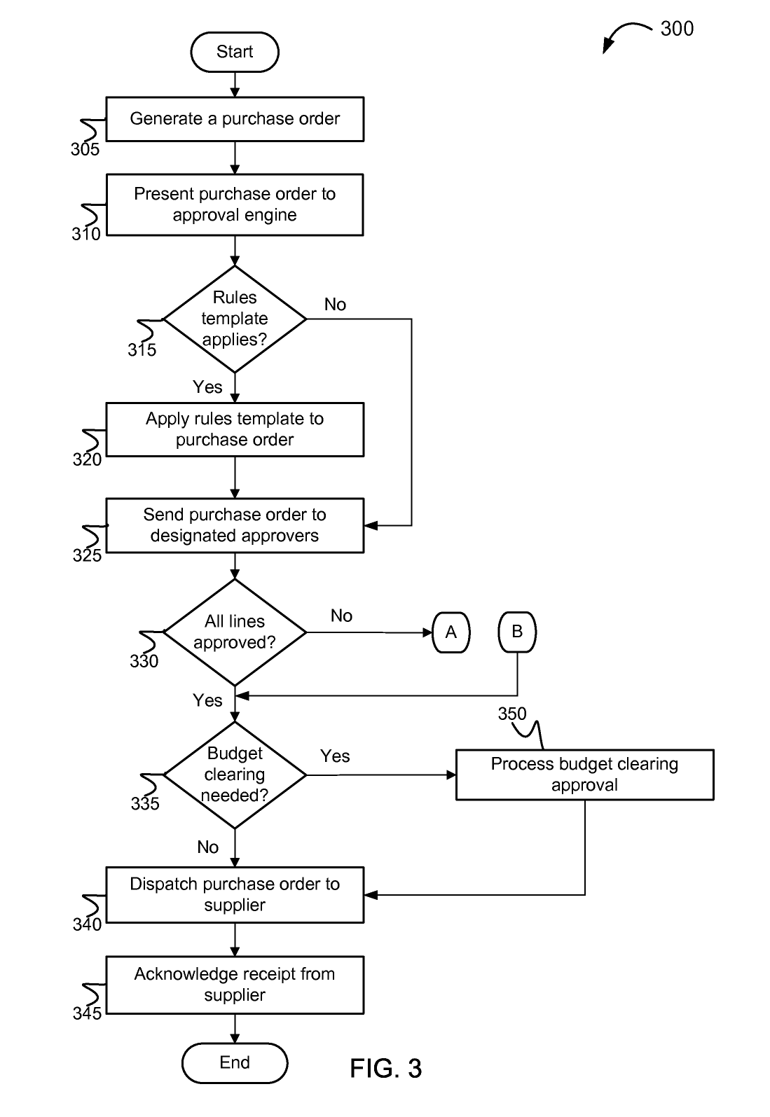

Turning now to FIG. 3, which illustrates a method 300 of implementing a purchase order approval workflow engine and approval framework, in accordance with one embodiment of the present invention. At process block 305, a purchase order is generated. The purchase order may be a work order, a manufacturing order, a services contract, a requisitions and request for quotes, a planning order, etc. Furthermore, the purchase order may be for any goods and/or services. Also, the purchase order may include multiple line items. In one embodiment, each line item may be independently approved from other line items. For example, if the purchase order includes a line item for hardware (e.g., 10,000 personal computers) and a line item for software (e.g., 1,000 copies of application X), then the approval process for the hardware line item may be at a different stage of the approval process from the software line item, and each may also require different approvers, a different number of approvers, etc. As such, approval from one line item may be received before other line items, and final approval for the entire purchase order may be dependent upon complete approval of all line items.

At process block 310, the purchase order is presented to an approval engine. In one embodiment, the purchase order originated from a purchaser and is destined for a supplier or suppliers. In addition, the purchaser may use the purchase order workflow engine to evaluate and route the purchase order, as well as manage multiple purchase orders, check purchase order approvals, set options and rules for purchase orders, etc. Accordingly, at decision block 315, a determination is made whether rules templates have been associated with the purchase order. In one embodiment, a rules template may include the approval routing (i.e., who are the approvers and what is the order of approval), shipping and receiving location restrictions and/or approval requirements, purchase order price and quantity restrictions, etc. In essence, any aspects of the purchase order and/or individual line items may be subject to configurable rules which guide and direct the approval flow and process for the purchase order.

If rules templates have been associated with the purchase order, then, at process block 320, the rules are applied to the purchase order. As such, the approvers, the approval requirements, and approval flow are established for the purchase order (i.e., an approval plan is set). At process block 325, the purchase order may be sent to the designated approvers. In one embodiment, special instructions may accompany the purchase order depending on the approver and the type of approval being requested.

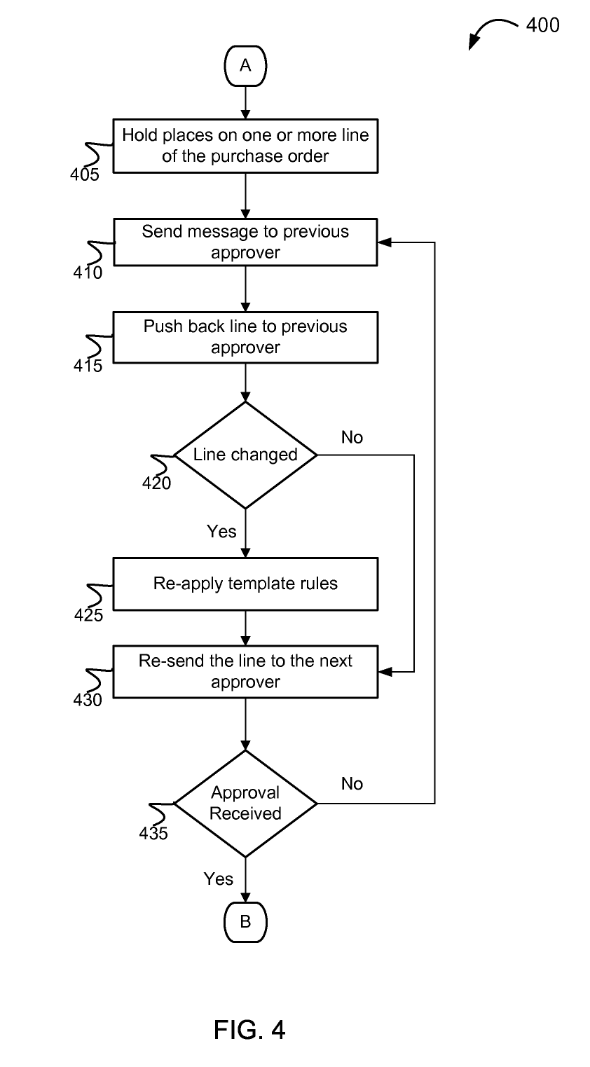

Further, at decision block 330, a determination is made whether all line items within the purchase order have been approved. If at least one line item has not been approved, then the process moves to point A, which will be discussed in detail in FIG. 4 below. Once all line items have been approved, then at process block 335, a determination is made whether budget clearing is needed. If budget clearing is needed, then at process block 350, budget approval processing is performed, and the purchase order is then dispatched to the supplier (or other designated destination) (process block 340).

At process block 345, once the purchase order has been dispatched the supplier may optionally acknowledge receipt of the purchase order. Additionally, interested parties may now execute against the dispatched purchase order. In one embodiment, communications regarding the purchase order approval status and other related activities associated with the purchase order may be transmitted via email, simple message service (SMS), etc. Further, the email message may provide direct access to the workflow environment directly in the email message (e.g., HTML email). Also, the approval workflow may provide purchasers and approvers with a view of multiple purchase orders and their respective status in the approval process. Further, the approvers may be given the option to take action on multiple purchase orders through this single view (e.g., mass approval options).

Turning now to FIG. 4, which illustrates a method 400 of implementing a purchase order approval workflow engine and approval framework, in accordance with a further embodiment of the present invention. Continuing from point A of FIG. 3, at process block 405, a hold may be placed on one or more of the line items from the purchase order. The hold may be at any point in the approval process by any designated approver. Further, the hold may be for any reason; for example, the price may be incorrect, the quantity may be incorrect, the shipping destination may be incorrect of restricted, etc. Accordingly, the hold on the line item may be accompanied with a message indicating the reason for the hold, and possible remedies as well as instructions regarding the hold (process block 410).

At process block 415, the line item may be “pushed back” in the approval process to another approver. In other words, the line item may be stepped back one approver in the process (nonetheless, more than one step back may be taken). As such, each line item may move forward and backward through the approval process, independent from the other line items, until each line item receives final approval from the final approver in the approval process.

At decision block 420, a determination is made whether a line item has been changed. If a line item is changed, then the rules template associated with that line item needs to be reapplied (process block 425) to determine if the line item is still in compliance with the rules. Furthermore, once compliance with the rules has been established, then at process block 430, the line item is re-sent to the approver next in the approval process. If at decision block 435, approval is received, then the process continues to point B and returns to FIG. 3. Otherwise, the process continues to process block 410, to step the approval back in the line of approvers.

In a further embodiment, at any point in the approval process an approver and/or reviewer may be dynamically added to the approval process. Accordingly, the line items and/or purchase order may be sent to the newly added approver in the approval process.

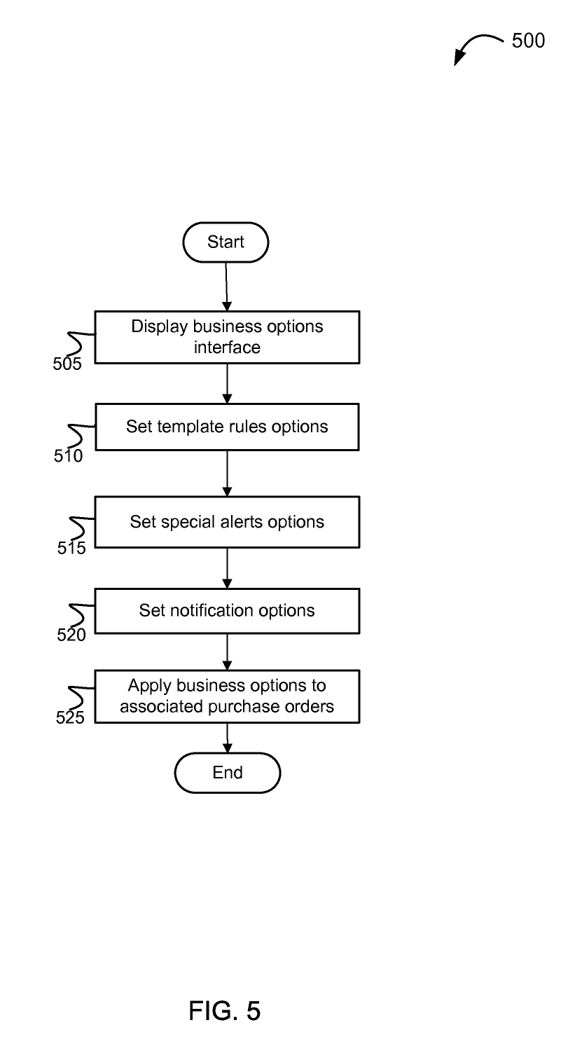

FIG. 5 is a flow diagram illustrating a method of setting business unit options for an approval framework workflow, in accordance with another embodiment of the present invention. At process block 505, a business options interface may be displayed. Business options may be customization options for the purchase order approval workflow engine and approval framework, which may be modified by an administrator, approver, purchaser, etc.

At process block 510, template rule options may be set. These rules may include any considerations which should be made by approvers in the approval process, for example, the approvers, the order of approval, the requirements for approval, etc. At process block 515, special alerts may be set. In one embodiment, special alerts (or messages) may be displayed to approvers and/or purchasers while viewing and/or approving purchase orders and line items. For example, such special messages may include a price adjustment message, a restricted country of shipping destination, vendor return rate information, quality rating alerts, etc. Further, at process block 540, notification options may be set, for example, the process for which purchasers, suppliers, approvers, etc. are notified (e.g., via email, SMS, etc.). Then, at process block 525, the business options may be applied to the associated purchase orders.

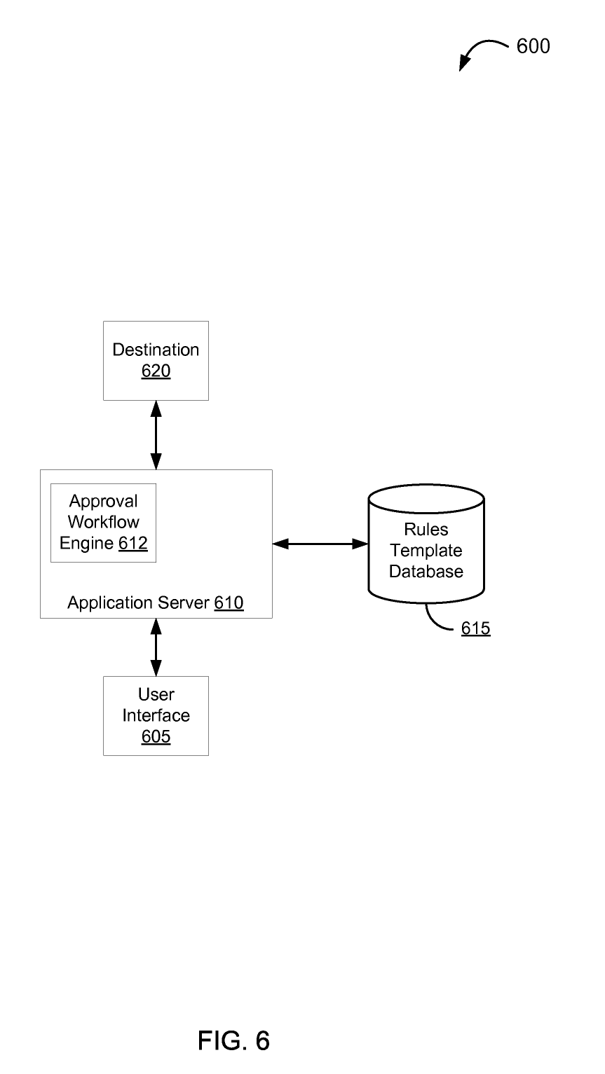

FIG. 6 illustrates a system 600 for implementing a purchase order approval workflow engine and approval framework, in accordance with embodiments of the present invention. System 600 includes a user interface 605 which may be configured to evaluate and route the purchase orders. System 600 further includes an application server 610 which includes an approval workflow engine 612. Approval workflow engine 612 may be configured to implement the approval process described above in FIGS. 3-5. Furthermore, system 600 may include a destination 620 (e.g., a supplier) and a rules template database 615 for storing rules and other business options.

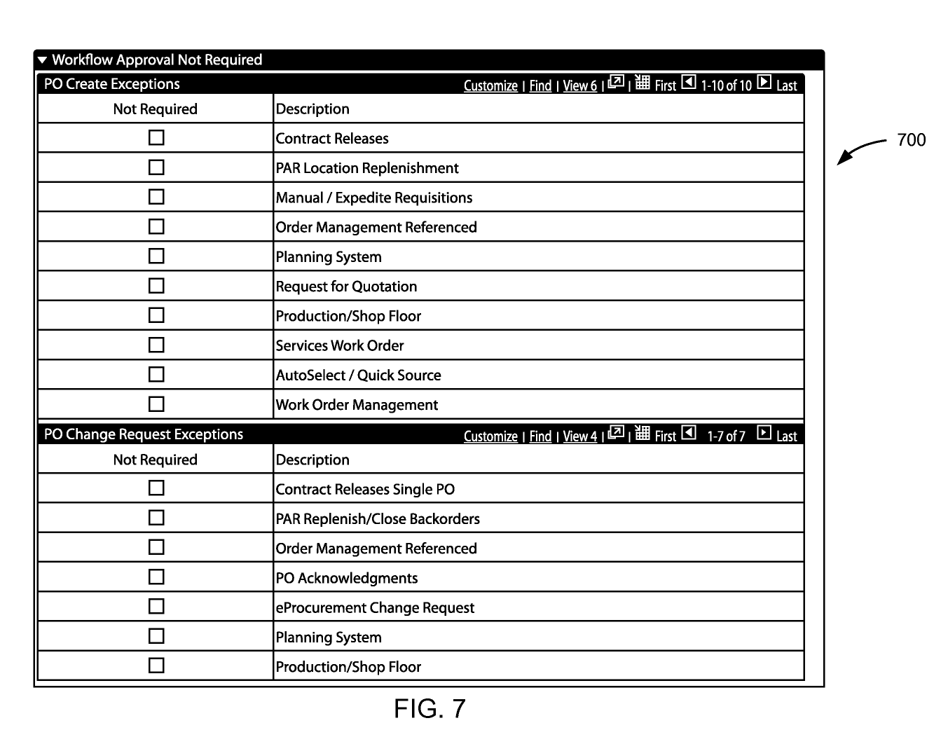

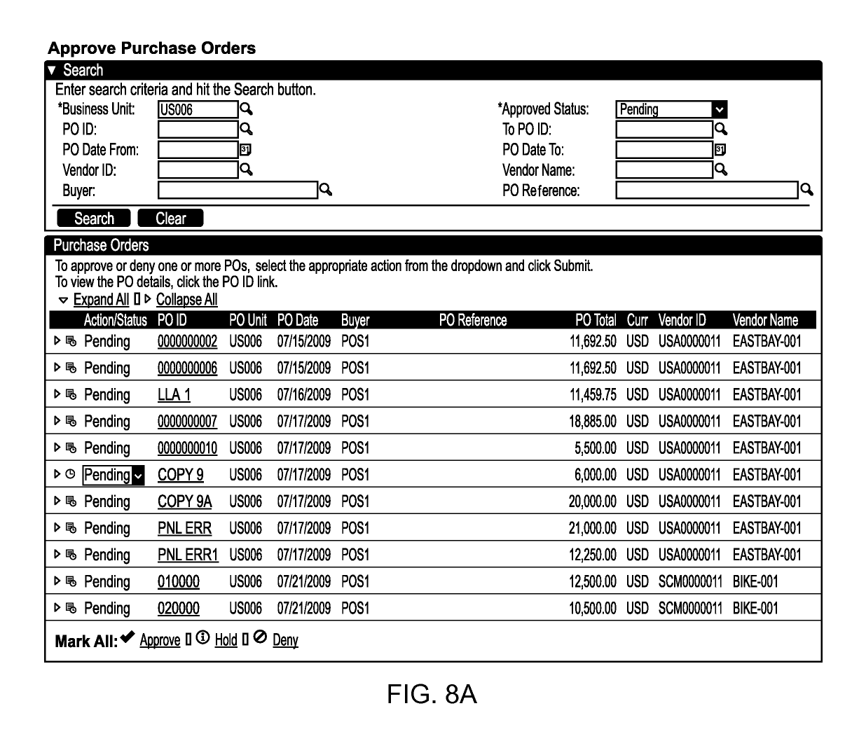

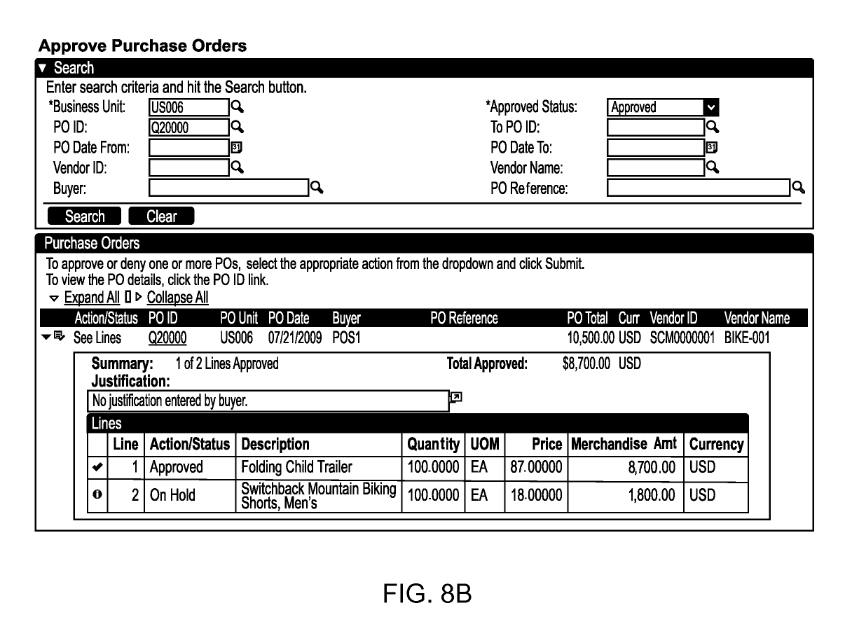

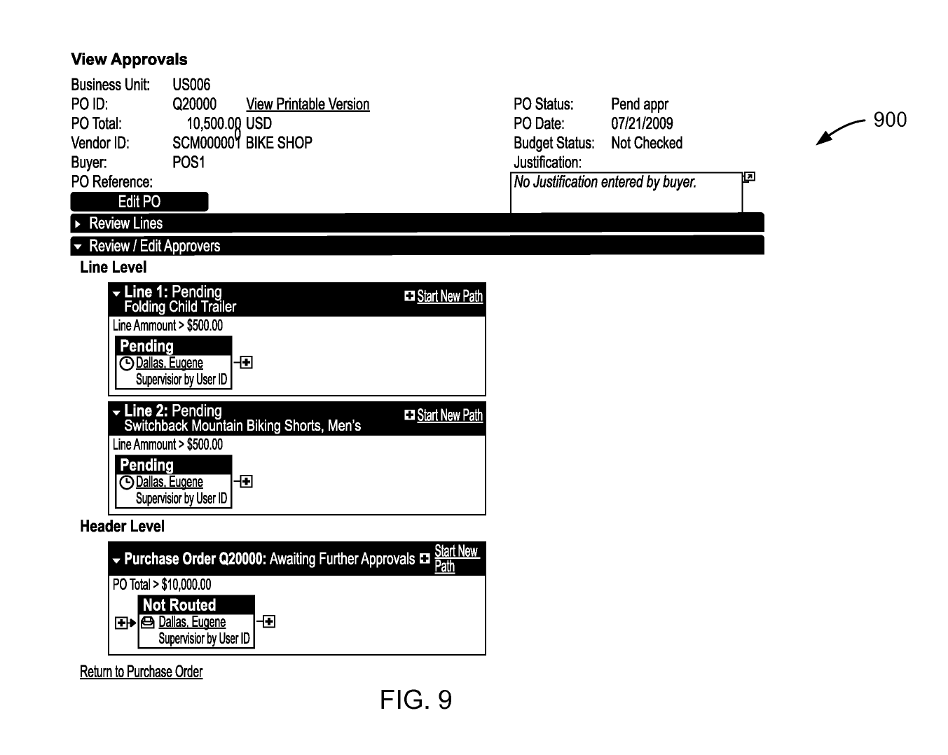

FIG. 7 illustrates a user interface 700 which provides for setting business unit options for an approval framework workflow, in accordance with another embodiment of the present invention. User interface 700 may include option settings for the business options in FIG. 5. FIGS. 8A and 8B are user interfaces which provide for an approval framework workflow purchase order view, in accordance with another embodiment of the present invention. The user interfaces include the approval framework workflow showing a purchase order mass approvals interface. Lastly, FIG. 9 is a user interface 900 which provides for an approval framework workflow line level purchase order approval view, in accordance with another embodiment of the present invention. User interface 900 includes line item approval views.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing a purchase order approval workflow engine and approval framework, the method comprising:
receiving, at an approval engine of an application server, from a purchaser, a purchase order, wherein the purchase order includes a plurality of line items;
applying, by the approval engine, one or more rules associated with the purchase order;
presenting the purchase order to one or more approvers and/or reviewers;
receiving, from the one or more approvers and/or reviewers, approval for each of the plurality of line items, wherein the approval of each line item is completed independent from any other line item;
receiving, at the approval engine, an indication that each of the plurality of line items is approved; and
transmitting, to a supplier, the purchase order.

2. A method of implementing a purchase order approval workflow engine and approval framework as in claim 1, further comprising receiving a hold indication, from a current approver in a sequence of approvers, for at least one of the plurality of line items.

3. A method of implementing a purchase order approval workflow engine and approval framework as in claim 2, further comprising presenting the purchase order to an approver based on a designated approver established in a routing setup, wherein the purchase order comprises a message indicating a reason for the hold.

4. A method of implementing a purchase order approval workflow engine and approval framework as in claim 3, further comprising modifying the purchase order by an approver relative to the current approver in the sequence of approver, wherein the approver is able to make changes any time during the approval process which would negate existing approvals and/or restart the approval process.

5. A method of implementing a purchase order approval workflow engine and approval framework as in claim 4, further comprising, in response to the modifying of the purchase order, re-applying the one or more rules associated with the purchase order.

6. A method of implementing a purchase order approval workflow engine and approval framework as in claim 5, further comprising:
presenting the modified purchase order to the approvers and/or reviewers in the sequence of approvers; and
based on each of the approvers providing approval of the purchase order, indicating that the modified purchase order is approved.

7. A method of implementing a purchase order approval workflow engine and approval framework as in claim 6, wherein the approval of the purchase order comprises line level and header level approvals.

8. A method of implementing a purchase order approval workflow engine and approval framework as in claim 1, wherein a first line item in the plurality of line items is at a different approval step from a second line item in the plurality of line items.

9. A method of implementing a purchase order approval workflow engine and approval framework as in claim 8, wherein the first line item is from a first line item category and the second line item is from a second line item category.

10. A method of implementing a purchase order approval workflow engine and approval framework as in claim 1, wherein the purchase order comprises one or more of the following: a work order, a manufacturing order, a services contract, a requisitions and request for quotes, and a planning order.

11. A method of implementing a purchase order approval workflow engine and approval framework as in claim 1, further comprising transmitting the purchase order to the one or more approvers and/or reviewers via email and/or simple message service (SMS).

12. A method of implementing a purchase order approval workflow engine and approval framework as in claim 1, further comprising displaying special messages or alerts.

13. A method of implementing a purchase order approval workflow engine and approval framework as in claim 12, further comprising configuring one or more of the following alert messages: a restricted shipping destination, a restricted supplier, and a product quality rating restriction.

14. A method of implementing a purchase order approval workflow engine and approval framework as in claim 1, further comprising:
providing an approval interface to approvers associated with the purchase orders; and
displaying the purchase orders to the associated approvers in a consolidated view.

15. A method of implementing a purchase order approval workflow engine and approval framework as in claim 14, further comprising:
receiving approval and/or denial of one or more of the additional purchase orders by an approver using the consolidated view; and
receiving changes to one or more of the additional purchase orders by an approver using the consolidated view.

16. A method of implementing a purchase order approval workflow engine and approval framework as in claim 1, further comprising dynamically associating new approvers and/or reviewers with the purchase order.

17. A system for implementing a purchase order approval workflow engine and approval framework, the system comprising:
an application server which includes an approval engine, wherein the approval engine is configured to receive a purchase order, wherein the purchase order includes a plurality of line items, access a rules database to determine one or more rules associated with the purchase order, apply the one or more rules associated with the purchase order, transmit the purchase order to one or more approvers, receive, from the one or more approvers approval for each of the plurality of line items, receive an indication that each of the plurality of line items are approved, and transmit, to a supplier, the purchase order.

18. A system for implementing a purchase order approval workflow engine and approval framework as in claim 17, wherein the approval of each line item is completed independent from any other line item.

19. A machine-readable medium for implementing a purchase order approval workflow engine and approval framework, having sets of instructions which, when executed by a machine, cause the machine to:
receive a purchase order, wherein the purchase order includes a plurality of line items;
apply one or more rules associated with the purchase order;
transmit the purchase order to one or more approvers;
receive, from the one or more approvers approval for each of the plurality of line items, wherein the approval of each line item is completed independent from any other line item;
receive, at the approval engine, an indication that each of the plurality of line items are approved; and
transmit, to a supplier, the purchase order.

20. A machine-readable medium for implementing a purchase order approval workflow engine and approval framework as in claim 19, wherein the sets of instructions which, when further executed by the machine, cause the machine to:
display options in an option user interface configured to provide option setting for associated purchase orders; and
receive a setting change for the one or more rules.

21. A machine-readable medium for implementing a purchase order approval workflow engine and approval framework as in claim 20, wherein the sets of instructions which, when further executed by the machine, cause the machine to:
receive a setting change for special alert options;
receive a setting change for notification options, wherein notification options include one or more of: email, SMS, telephone, and voicemail; and
apply the newly set options to the associated purchase orders.
